(19) United States
(12) Patent Application Publication
(10) Pub. No.: US 2004/0094497 A1
(43) Pub. Date: May 20, 2004

(54) Arrangement for placing auxiliary ropes of crane hoist gears

(76) Inventors: Hannu Oja, (US); Jukka Toivonen, Hyvink?auml;?auml; (FI); Soini Söderena, R?ouml;ykk?auml; (FI); Hannu Rossi, Iittala (FI)

Correspondence Address: BIRCH STEWART KOLASCH & BIRCH, PO BOX 747, FALLS CHURCH, VA, 22040-0747, US

(21) Appl. No.: 10/380,512

(22) PCT Filed: Sep. 13, 2001
(86) PCT No.: PCT/FI01/00796

(30) Foreign Application Priority Data
Sep. 14, 2000 (FI) 20002030

(51) Int. Cl. B66C 13/06

(52) U.S. Cl. 212/274

(57) ABSTRACT

An arrangement for placing auxiliary ropes of hoist gears in a crane, the crane comprising a trolley (1); hoist gears (2) with hoist drums (3) placed in the trolley (1); hoisting ropes (4) arranged on the hoist drums (3); a loading member (7) suspended from the trolley (1) on the hoisting ropes (4) and having sheaves (8) for the hoisting ropes, through which the hoisting ropes pass back to the trolley; four auxiliary gears (10) placed in the trolley (1) for controlling swinging and skewing of the loading member (7) and the load attached thereto; auxiliary ropes (12) arranged on rope drums (11) of the auxiliary gears (10); and sheaves (13) for the auxiliary ropes in the loading member (7), through which sheaves the auxiliary ropes (12) passing diagonally from the rope drums (11) of the auxiliary gears (10) are guided to spaces (14) in the hoist drums reserved for the auxiliary ropes (12).

### BACKGROUND OF THE INVENTION

The invention relates to an arrangement for placing auxiliary ropes of hoist gears in a crane, the crane comprising a trolley; hoist gears with hoist drums placed in the trolley; hoisting ropes arranged on the hoist drums; a loading member suspended from the trolley on the hoisting ropes and having sheaves for the hoisting ropes, through which the hoisting ropes pass back to the trolley; four auxiliary gears placed in the trolley for controlling swinging and skewing of the loading member and the load attached thereto; auxiliary ropes arranged on rope drums of the hoist gears; and sheaves for the auxiliary ropes in the loading member, through which sheaves the auxiliary ropes passing diagonally from the rope drums of the auxiliary gears are guided to spaces in the hoist drums reserved for the auxiliary ropes.

A problem with hoist gears used for material handling is swinging and skewing of a load hanging freely on the hoist ropes in connection with horizontal movements. Several methods are known how to prevent and reduce the swinging and skewing of the load.

Electrical systems are one main group of these systems. In the electrical systems horizontal accelerations of the hoist gears are adjusted in synchronization with the pendulum motion of the load, whereby the load suspension point (position of the hoist gears above the load) is transferred at an acceleration rate that exceeds the swinging of the load in the direction of the swing, and consequently the pendulum motion reduces.

Another main group consists of mechanical systems, in which load suspension is arranged with diagonal hoist ropes or diagonal ropes mounted in addition to the hoist ropes. By means of the diagonal ropes the load is exposed to horizontal forces, by which the load swinging is prevented or reduced.

From Finnish patent 101,466 is known an arrangement, in which four auxiliary gears are connected to a load suspension member with diagonal ropes, and the load swinging is prevented by controlling the auxiliary gears electrically. In this arrangement the auxiliary gear ropes pass from the loading member directly to the hoist gear drums and are wound into grooves on the hoist drums reserved for the auxiliary ropes.

In cranes having extensive hoisting height and high speeds of motion the problems with load control increase, because in the prior art:

grooving reserved for the auxiliary rope increases the length of the hoist drum, which cannot be implemented in practice, due to the limited space of the crane trolley,

performance of a single diagonal auxiliary rope is insufficient or the size of the auxiliary gear grows excessively to be feasible,

rope travel along the drums, resulting from the extensive hoisting height, produces increased rope angles, and

it is impossible to place the hoisting ropes and the auxiliary ropes in an optimal manner because of rope crossing.

### SUMMARY OF THE INVENTION

The object of the invention is to provide an arrangement by which the above drawbacks can be eliminated. This is achieved by the arrangement of the invention, which is characterized in that at least one set of additional sheaves are arranged in the trolley for the auxiliary ropes, through which sheaves the auxiliary ropes pass to auxiliary rope spaces of the hoist drums.

It is advantageous if the auxiliary rope spaces also allow multiple winding of auxiliary ropes.

The invention is based on the idea that the auxiliary ropes are vertically arranged in a symmetrical manner such that their angles to the hoist drums remain substantially the same (preferably perpendicular to the hoist drum axes) irrespective of the height at which the hoisting member with its load is at any given time. Thus, the present arrangement also enables vertical placing of the hoisting ropes in a symmetrical manner. In this manner it is possible to avoid uncontrolled lateral shifts of the load caused by asymmetrical loading.

Following considerable advantages are achieved by the invention:

because a return rope is deflected, the performance of each auxiliary gear doubles, whereby the reduction effect of load swinging produced by one gear can be economically doubled respectively,

to make the auxiliary rope that is returning from the loading member pass through a stationary additional sheave back to a space reserved in the hoist drum provides stationary points for the auxiliary ropes, whereby a change in hoisting height does not affect the reduction effect produced,

to wind the auxiliary rope in multiple layers onto a drum end on a narrow lateral area enables placing of the hoisting ropes in the middle of the drum, whereby the hoisting rope arrangement can be implemented fully symmetrically, and no rope crossing occurs at any hoisting level, and

the hoist drums can be manufactured shorter, which enables placing in the trolley even at extensive hoisting heights.

### BRIEF DESCRIPTION OF THE DRAWINGS

In the following, the invention will be described in greater detail by means of one preferred embodiment, with reference to the attached drawings, wherein

FIG. 1 is a simplified schematic view of an arrangement according to the invention, a trolley seen in the travel direction;

FIG. 2 is a side view of the arrangement of FIG. 1;

FIG. 3 is a top view of the arrangement of FIG. 1; and

FIG. 4 shows enlarged auxiliary rope spaces.

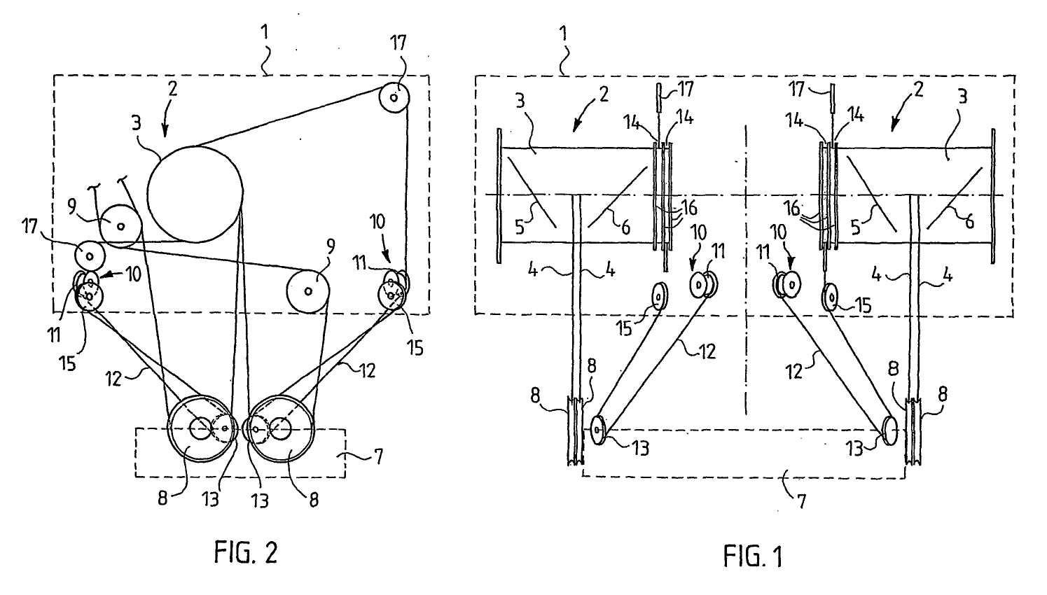

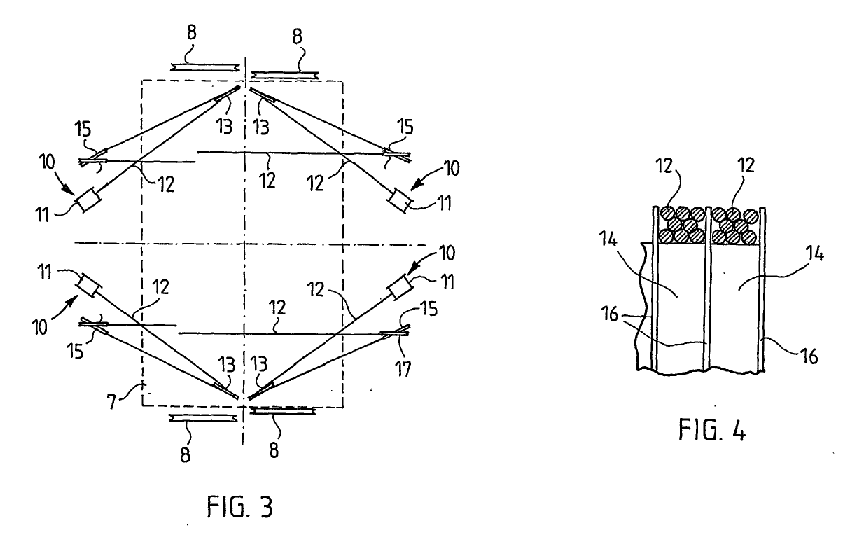

### DETAILED DESCRIPTION OF THE INVENTION

The arrangement shown in the drawings comprises two hoist gears 2 with hoist drums 3 placed in a crane trolley 1. These elements are arranged in the trolley 1 such that their longitudinal axes are in the same line A. Two hoisting ropes 4 are arranged in parallel on the hoist drum 3 of both hoist gears 2 such that grooves 5 and 6 reserved for the ropes on the surface of the hoist drum 3 are opposite in direction. Suspended on the hoisting ropes 4, there is a loading member 7, for fastening a load to be hoisted (not shown), having sheaves 8 for the hoisting ropes 4, through which the hoisting ropes 4 pass back to the trolley 1. The sheaves 8 are located in the loading member 7 substantially directly below the longitudinal middle points of the hoist drums 3, whereby the position of the hoisting ropes remains substantially symmetrical in the vertical direction despite different hoisting heights. The hoisting ropes 4 pass through additional sheaves 9 to the trolley 1 and are secured to the crane through overload protections (not shown), if any.

The arrangement also comprises four auxiliary gears 10 placed in the trolley 1 for controlling swinging and skewing of the loading member 7 and load fastened thereto. Advantageously, the auxiliary gears 10 are arranged in a rectangle such that one auxiliary gear 10 is located in each corner of the rectangle. On a rope drum 11 of each of the auxiliary gears 10 is arranged an auxiliary rope 12 which passes diagonally into sheaves 13 located in the loading member 7 and through them back towards the hoist drums 3 and spaces 14 that are advantageously designed and reserved for them in the hoist drums 3. The sheaves 13 are also advantageously arranged in a rectangle such that one sheave 13 is located in each corner of the rectangle. It is necessary to arrange the auxiliary ropes 12 diagonally in order that vertical forces, which are required to prevent or reduce swinging or skewing, could be exerted on the loading member 7 and the load by means of the auxiliary gears 12 and the auxiliary ropes. Therefore, it is also possible that the hoisting ropes 4 are positioned fully vertically. Control of swinging and skewing of this kind is described briefly later on in the text.

The most substantial feature of the arrangement described here is that at least one set of additional sheaves 15 is arranged in the trolley 1 for the auxiliary ropes 12, through which sheaves the auxiliary ropes 12 arriving from the loading member 7 and the first sheaves 13 therein are applied to auxiliary rope spaces 14 of the hoist drum 3. In this manner, each auxiliary rope 12 can be provided with a stationary point in the trolley 1 relative thereto and independent of the hoisting height, whereby travelling of the auxiliary ropes 12 in relation to the drum on the side of the trolley 1, which occurs in previous arrangements, is avoided. In addition, when the spaces 14 for the auxiliary ropes are provided at the hoist drum 3 ends on a considerably narrow area e.g. by means of flanges 16 such that the auxiliary ropes can be wound onto a plurality of layers, the angle of the auxiliary ropes 12 to the hoist drum 3 remains almost constant at any hoisting height, and it is possible to make the hoist drum 3 considerably shorter than previously.

Between the additional sheaves 15 and the hoist drums 3 there are further arranged sheaves 17, through which the auxiliary ropes 12 pass, but these are mainly arranged to ensure free passage for the auxiliary ropes 12.

The auxiliary gears 10 can be, for instance, identical, mechanically independent systems according to Finnish patent 101,466, the control of which systems is implemented completely electrically and determined on the basis of the weighting data of the auxiliary rope 12, rotating rate of the rope drum 11, and the like variables. There is always a sufficient amount of auxiliary rope 12 in store on the rope drum 11, and consequently the compensation required by different geometries of the auxiliary ropes 12 and the hoist ropes 4 will be automatically solved. By means of a control system controlling the auxiliary gears forces exerted on each auxiliary rope 12 are controlled on the basis of the above-mentioned variables such that the loading member 7 and the load suspended thereto are not allowed to swing or skew. It is not necessary to position the auxiliary gears 10 in a completely symmetrical manner, because asymmetry, if known in advance, can be taken into account by the above control system. This known method is described in greater detail in said patent.

The above specification is only intended to illustrate the basic idea of the invention. However, a person skilled in the art can implement its details in a variety of ways within the scope of the attached claims.

1. An arrangement for placing auxiliary ropes of hoist gears in a crane, the crane comprising
a trolley (1);
hoist gears (2) with hoist drums (3) placed in the trolley (1);
hoisting ropes (4) arranged on the hoist drums (3);
a loading member (7) suspended from the trolley (1) on the hoisting ropes (4) and having sheaves (8) for the hoisting ropes, through which the hoisting ropes pass back to the trolley;
four auxiliary gears (10) placed in the trolley (1) for controlling swinging and skewing of the loading member (7) and the load attached thereto;
auxiliary ropes (12) arranged on rope drums (11) of the auxiliary gears (10); and
sheaves (13) for the auxiliary ropes in the loading member (7), through which sheaves the auxiliary ropes (12) passing diagonally from the rope drums (11) of the auxiliary gears (10) are guided to spaces (14) in the hoist drums reserved for the auxiliary ropes (12),
characterized by
providing at least one set of additional sheaves (15) are arranged in the trolley (1) for the auxiliary ropes (12), through which sheaves the auxiliary ropes (12) pass to auxiliary rope spaces (14) of the hoist drums, and allowing multiple winding of the auxiliary ropes in the auxiliary rope spaces (14).

2. A system as claimed in claim 1, characterized in that the auxiliary rope spaces (14) of the hoist drums (3) are many times narrower than the spaces reserved for hoisting ropes (4).

3. A system as claimed in claim 2, characterized in that the auxiliary rope spaces (14) of the hoist drums (3) are spaces separated with flanges (16).

4. A system as claimed in any one of preceding claims, characterized in that there are two hoist gears (2) and that two hoisting ropes (4) are arranged in parallel on the hoist drum (3) of each hoist gear (2) such that grooves (5, 6) reserved for them on the surface of the hoist drum are opposite in direction.
